(19) United States
(12) Patent Application Publication
(10) Pub. No.: US 2025/0312903 A1
(43) Pub. Date: Oct. 9, 2025

(54) Valve Spring Lock Plate Installation and Removal Tool

(71) Applicant: SHUHUI QIAN, NINGBO CITY (CN)

(72) Inventor: SHUHUI QIAN, NINGBO CITY (CN)

(21) Appl. No.: 18/629,949

(22) Filed: Apr. 9, 2024

(51) Int. Cl. B25B 27/26; B25B 27/00; F16K 99/00

(52) U.S. Cl. CPC B25B 27/26; F16K 99/00; B25B 27/0035

(57) ABSTRACT

The invention relates to a valve spring lock plate installation and removal tool, which includes a gripping body, two replaceable extension pieces, and at least a plurality of arc-shaped clamp heads. The replaceable extension pieces are respectively provided in the assembling sections of the gripping body in a detachable state, and each of the replaceable extension pieces has at least one magnetic insertion structure arranged at one end thereof. The arc-shaped clamp head has at least one connecting portion provided on one side thereof, which can cooperate with the magnetic insertion structure, so that the arc-shaped clamp head is magnetic. The arc-shaped clamp head has at least one step portion formed an inner side thereof, when the arc-shaped clamp heads are operated to relatively close to the outer edge of the limiting valve lock plate, the step portion can abut against the valve lock plate and have a limiting effect.

### BACKGROUND OF THE PRESENT INVENTION

### Field of Invention

The invention relates to the field of loading and unloading tools, in particular to a valve spring lock plate installation and removal tool suitable for various specifications.

### Description of Related Arts

The valve spring lock plate is a small part used to fix the valve spring of automobile engine, it ensures that the valve can be opened and closed correctly in the valve guide without falling off, this lock plate is usually composed of two halves of arc blocks, installed at the end of the valve stem, and clamped by the force of the compression spring, when the spring is compressed, the lock plate will move inward, so that it is locked in a groove on the valve stem, and then fix the spring and the valve stem. The design of the valve spring locking plate allows the valve to be opened and closed when the engine is running, preventing the spring from falling off and causing engine failure.

The valve spring lock plates of different vehicles have different specifications, and the conventional installation and removal tool is usually a fixed-specification valve spring clamp (Valve Spring C-Clamp) or called valve pliers. The head end of a single valve clamp is designed into a fixed C-shape, and a plurality of tools must be selected to replace the use of different specifications. When using them, the two ends of the tool are fixed respectively to the upper and lower ends of the valve spring, and the two ends of the valve clamp are pushed together manually, compressing the valve spring and exposing the lock pieces. Once the spring is compressed, the lock pieces loosen, and can be removed from the groove of the valve stem using needle-nose pliers or dedicated lock piece hooks. However, it is known that although the valve clamp has basic operating functions, it is extremely inconvenient because multiple tools must be replaced to apply different specifications of valve spring locking plates, and the convenience of use is also greatly reduced. Therefore, how to develop an innovative structure suitable for multiple specifications is actually an important issue for the industry.

### SUMMARY OF THE PRESENT INVENTION

Therefore, the main purpose of the present invention is to solve the shortcomings of the conventional structure and provide a valve spring lock plate installation and removal tool, which includes: a gripping body, having two gripping parts arranged in a cross manner, two assembling sections provided at one end of the different gripping parts, and a pivot connector connecting the two gripping parts and the two assembling sections, so that the two gripping parts are configured to be able to control the assembling sections to be relatively close or away from each other with the pivot connector as the axis; two replaceable extension pieces, respectively provided in the assembling sections of the gripping body in a detachable state, wherein each of the replaceable extension pieces has at least one magnetic insertion structure provided on one end thereof; and at least a plurality of arc-shaped clamp heads, each of which has at least one connecting portion provided on one side of the arc-shaped clamp head to cooperate with the magnetic insertion structure, so that the arc-shaped clamp heads are magnetic when assembled on the assembling sections of the gripping body, wherein each of the arc-shaped clamp heads has a step portion formed on an inner side thereof, and when the gripping parts control the assembling sections, and are relatively adjacent to an outer edge of a limiting valve lock piece by the arc-shaped clamp heads, the step portion is capable of resisting the valve lock piece and has a limiting effect. The following is a further description of the preferred embodiments of the present invention in conjunction with the drawings, in order to enable those familiar with the technology related to the present invention to implement the invention according to the statements in this specification.

### BRIEF DESCRIPTION OF THE DRAWINGS

FIG. 1 is an exploded view of the structure of the present invention.

FIG. 2 is a partial perspective view of the structure of the present invention.

FIG. 3 is a perspective view of the structure of the present invention.

### DETAILED DESCRIPTION OF THE PREFERRED EMBODIMENT

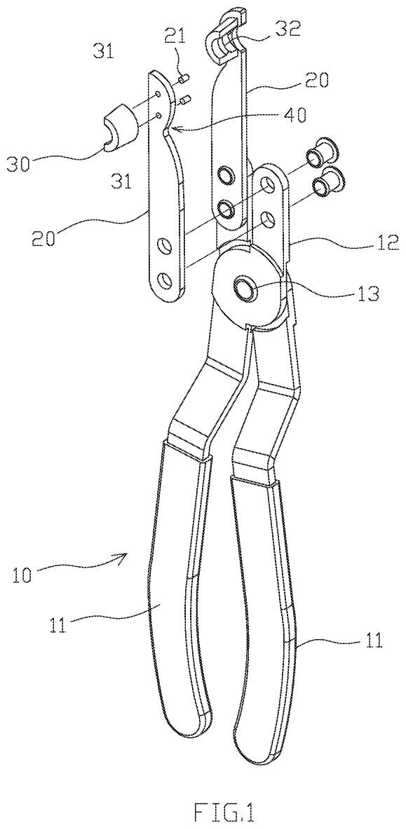

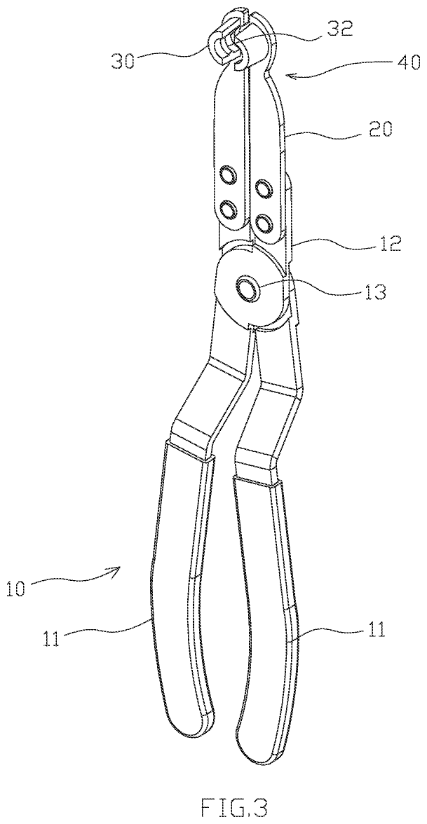

First, referring to FIGS. 1 to 3, the present invention discloses a valve spring lock plate installation and removal tool, which includes:
a gripping body 10, having two gripping parts 11 arranged in a cross manner, two assembling sections 12 provided at one end of the different gripping parts 11, and a pivot connector 13 connecting the two gripping parts 11 and the two assembling sections 12, so that the two gripping parts 11 are configured to be able to control the assembling sections 12 to be relatively in proximity or away from each other with the pivot connector 13 as the axis;
two replaceable extension pieces 20, respectively provided in the assembling sections 12 of the gripping body 10 in a detachable state, wherein each of the replaceable extension pieces 20 has at least one magnetic insertion structure 21 provided on one end thereof; and
at least a plurality of arc-shaped clamp heads 30, each of which has at least one connecting portion 31 provided on one side of the arc-shaped clamp head 30 to cooperate with the magnetic insertion structure 21, so that the arc-shaped clamp heads 30 are magnetic when assembled on the assembling sections 12 of the gripping body 10, wherein the implementation of the present invention allows the replacement of arc-shaped clamp heads 30 of different specifications, which has the advantage of being multipurpose in one piece, wherein each of the arc-shaped clamp heads 30 has a step portion 32 formed on an inner side thereof, and when the gripping parts 11 control the assembling sections 12, and are relatively adjacent to the outer edge of the limiting valve lock piece by the arc-shaped clamp heads 30, the step portion 32 is capable of resisting the valve lock piece and has a limiting effect.

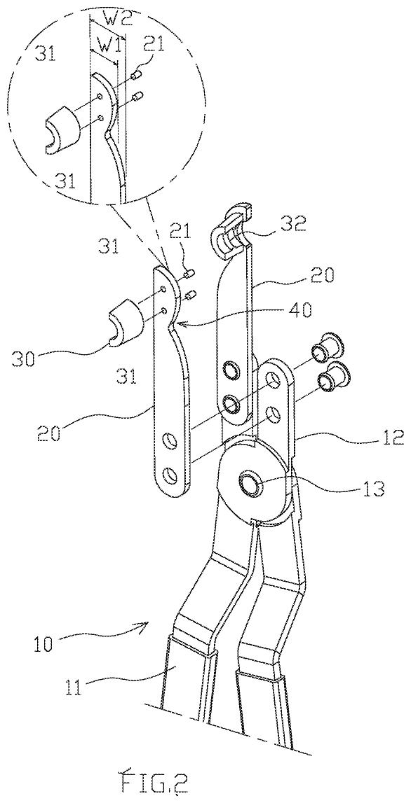

Regarding the detailed description of the structure of the present invention, referring to FIGS. 1 to 3. In practice, the connecting portions 31 of the arc-shaped clamp heads 30 are in the form of a metal insert, so that the arc-shaped clamp heads 30 are inserted and connected to the magnetic insertion structure 21 in a detachable and replaceable state. As shown in FIG. 2, one end of the replaceable extension pieces 20 is arc-shaped at the outer edge of the magnetic insertion structure 21 and is reduced inwardly to form a reduced diameter section 40. The reduced diameter section 40 allows the two sides of the replaceable extension pieces 20 to have different widths. The reduced diameter section 40 effectively reduces the volume and facilitates operation and movement when the replaceable extension pieces are inserted into a valve (not shown) for installation or removal. Therefore, compared with the conventional one-piece structure, the present invention has many advantages, such as being applicable to multiple specifications, having a simple structure, being easy to carry, and improving convenience of use.

What is claimed is:

1. A valve spring lock plate installation and removal tool, comprising:
a gripping body, having two gripping parts arranged in a cross manner, two assembling sections provided at one end of the different gripping parts, and a pivot connector connecting the two gripping parts and the two assembling sections, so that the two gripping parts are configured to be able to control the assembling sections to be relatively close or away from each other with the pivot connector as the axis;
two replaceable extension pieces, respectively provided in the assembling sections of the gripping body in a detachable state, wherein each of the replaceable extension pieces has at least one magnetic insertion structure provided on one end thereof; and
at least a plurality of arc-shaped clamp heads, each of which has at least one connecting portion provided on one side of the arc-shaped clamp head to cooperate with the magnetic insertion structure, so that the arc-shaped clamp heads are magnetic when assembled on the assembling sections of the gripping body,
wherein each of the arc-shaped clamp heads has a step portion formed on an inner side thereof, and when the gripping parts control the assembling sections, and are relatively adjacent to an outer edge of a limiting valve lock piece by the arc-shaped clamp heads, the step portion is capable of resisting the valve lock piece and has a limiting effect.

2. The valve spring lock plate installation and removal tool, as recited in claim 1, wherein the connecting portions of the arc-shaped clamp heads are in the form of a metal insert, so that the arc-shaped clamp heads are inserted and connected to the magnetic insertion structure in a detachable and replaceable state.

3. The valve spring lock plate installation and removal tool, as recited in claim 1, wherein one end of the replaceable extension pieces is arc-shaped at the outer edge of the magnetic insertion structure and is reduced inwardly to form a reduced diameter section, wherein the reduced diameter section allows the two sides of the replaceable extension pieces to have different widths.
